(19) United States
(12) Patent Application Publication
(10) Pub. No.: US 2018/0218248 A1
(43) Pub. Date: Aug. 2, 2018

(54) UNOBTRUSIVE TAGGING OF THE ENVIRONMENT TO AID ROBOTIC OR COMPUTER VISION CLASSIFICATION USING INFRARED REFLECTIVE COMPUTER VISION TAGS

(71) Applicant: Peter Haas, Providence, RI (US)

(72) Inventor: Peter Haas, Providence, RI (US)

(21) Appl. No.: 15/879,067

(22) Filed: Jan. 24, 2018

Related U.S. Application Data
(60) Provisional application No. 62/451,291, filed on Jan. 27, 2017.

(51) Int. Cl. G06K 19/06

(52) U.S. Cl. CPC G06K 19/0614

(57) ABSTRACT

An invisible infrared reflective computer vision tag includes an infrared reflective material with a printed or painted fiducial marker using an infrared opaque dye, toner, pigment or surface, covered by an infrared transparent dye toner, pigment or material.

### CROSS REFERENCE TO RELATED APPLICATIONS

This application claims benefit from U.S. Provisional Patent Application Ser. No. 62/451,291, filed Jan. 27, 2017, which is incorporated by reference in its entirety.

### STATEMENT REGARDING GOVERNMENT INTEREST

None.

### BACKGROUND OF THE INVENTION

The invention generally relates to computer vision, and more specifically to unobtrusive tagging of the environment to aid robotic or computer vision classification using infrared (IR) reflective computer vision tags.

A robot is generally an electro-mechanical machine with actuators, sensors, and electronic processes for making decisions. Mobile robots have the capability to move around in their environment and are not fixed to one physical location. To make decisions about and interact with its environment, a robot sometimes needs to classify objects within the environment. This can be accomplished through computer vision and can be aided by computer vision readable tags.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods for the unobtrusive tagging of the environment to aid robotic or computer vision classification using infrared (IR) reflective computer vision tags.

In general, in one aspect, the invention features an invisible infrared reflective computer vision tag including an infrared reflective material with a printed or painted fiducial marker using an infrared opaque dye, toner, pigment or surface, covered by an infrared transparent dye toner, pigment or material.

In another aspect, the invention features an invisible infrared reflective computer vision tag including an infrared opaque material with a printed or painted fiducial marker using an infrared reflective dye, toner, pigment or material, covered by an infrared transparent dye toner, pigment or surface.

In still another aspect, the invention features an invisible infrared reflective computer vision tag including an infrared reflective layer, a printed fiducial marker, and a printed infrared transparent layer.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1a illustrates an exemplary layered invisible infrared reflective computer vision tag.

FIG. 1b illustrates an exemplary unmanned aerial vehicle finding a docking station or a delivery location in a complex urban environment using a layered invisible infrared reflective computer vision tag.

FIG. 2a illustrates an exemplary single layer invisible infrared reflective computer vision tag.

FIG. 2b illustrates an exemplary vehicle with a single layer invisible infrared reflective computer vision tag applied directly to the body of the vehicle, using layers of infrared absorptive and infrared transparent pigments.

FIG. 3a illustrates an exemplary fabric invisible infrared reflective computer vision tag.

FIG. 3b illustrates an exemplary dress identified with a fabric invisible infrared reflective computer vision tag.

FIG. 4 illustrates an exemplary invisible infrared reflective computer vision tag illuminated by an infrared illuminator, observed by an infrared camera and interpreted by a computer.

FIG. 5a is an example of invisible infrared reflective computer vision tags taken by an RGB camera under typical daytime lighting conditions.

FIG. 5b illustrates the same tags as shown in FIG. 5a, observed through an infrared camera under an infrared illuminator.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The following terms may be useful in understanding the present invention.

Fiducial Marker

A fiducial marker or fiducial is an object placed in the field of view of an imaging system which appears in the image produced, for use as a point of reference or a measure. It may be either something placed into or on the imaging subject, or a mark or set of marks in the reticle of an optical instrument.

Infrared

Infrared radiation is electromagnetic radiation with longer wavelengths than those of visible light, and is invisible to the human eye. It extends from the nominal red edge of the visible spectrum at 700 nanometers (frequency 430 THz), to 1 millimeter (frequency 300 GHz).

QR Code

QR code (abbreviated from Quick Response Code) is the trademark for a type of matrix barcode (or two-dimensional barcode) first designed for the automotive industry in Japan.

AprilTag

An AprilTag is a matrix barcode, useful for a wide variety of tasks including augmented reality, robotics, and camera calibration.

TopCodes

TopCodes are a circular black and white symbol that can register numeric data and resolve in formats as small as 15×15 pixels.

Barcodes

A barcode is a machine-readable code in the form of numbers and a pattern of parallel lines of varying widths, printed on and identifying an item.

Infrared Illuminator

Infrared Illuminators are electrical devices which emit infrared radiation.

Infrared Camera

Also called a Thermographic camera, an Infrared Camera is a device that forms an image using infrared radiation, similar to how a common camera that forms an image using visible light. Instead of the 400-700 nanometer range of the visible light camera, infrared cameras operate in wavelengths 700 nanometers (frequency 430 THz), to 1 millimeter (frequency 300 GHz).

Retroreflector

A retroreflector is a device or surface that reflects light back to its source with a minimum of scattering. In a retroreflector an electromagnetic wavefront is reflected back along a vector that is parallel to but opposite in direction from the wave's source.

Now turning to the invention, as mentioned above, to understand and interact with its environment, a robot needs to classify objects within the environment. While there are many methods for accomplishing this, one of the most common is to tag objects in the environment with a visually coded tag or fiducial.

Visual tags such as QR codes, AprilTags and barcodes are commonly used in robotics and computer vision for object identification, categorization and interaction. These visual tagging methods provide a simple, highly effective pattern for robots and computer vision algorithms to resolve with cameras. Unfortunately, these codes are not aesthetically appealing to humans, and an environment covered in these tags in the manner needed for complex robotic interaction is not likely to be implemented in most public and private spaces.

This application presents novel improvements in fiducial marker computer vision tags to render them invisible to the human eye using infrared reflective and infrared transparent materials, inks and pigments. Invisible infrared reflective computer vision tags represent a novel example of markers that are computer readable but also invisible to the human eye using reflectors.

The invisible infrared reflective computer vision tags of the present invention provide a computer readable fiducial marker that is invisible to the human eye and can blend into background environments. By combining infrared reflective materials and infrared transparent dyes it provides for the creation of computer readable infrared fiducial markers without the need for infrared emitting material. It may be used by industries for robot navigation and classification, stationary computer vision tasks like vehicular identification, and for augmented reality triggers.

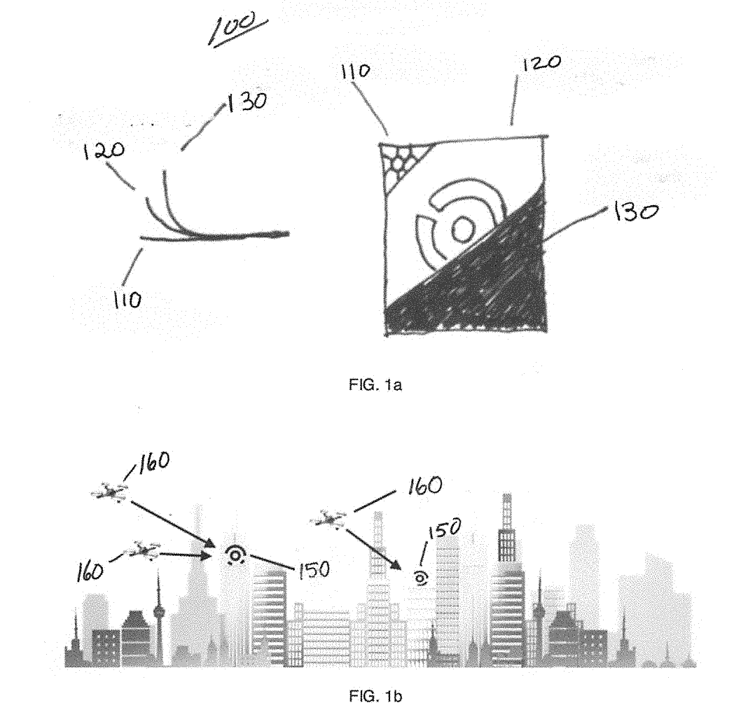

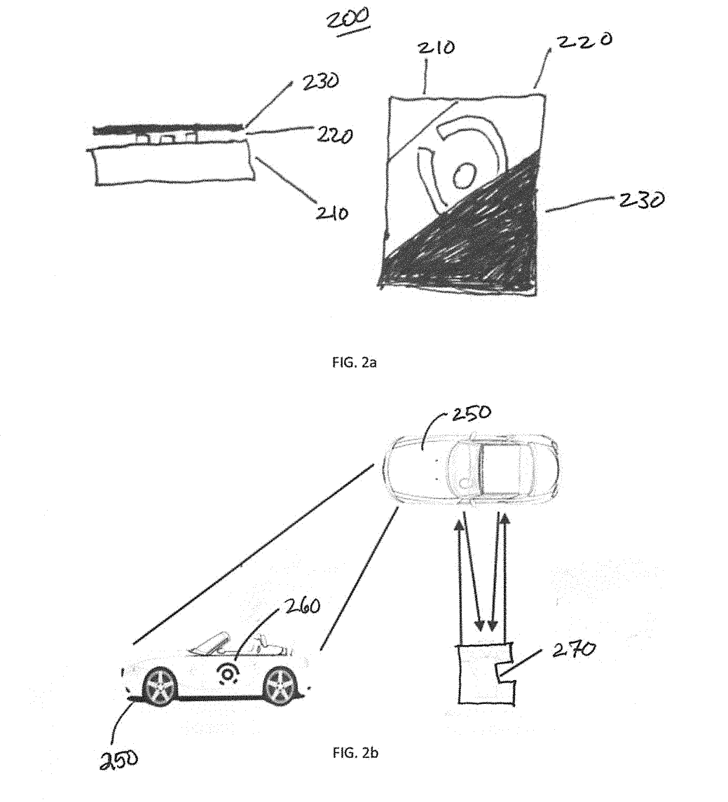

Invisible infrared reflective computer vision tags such as those shown in FIG. 1a can be made by leveraging existing or new fiducial systems, including but not limited to QR codes, TopCodes, AprilTags, or barcodes, and 1) printing with traditional dye inks, toners or pigments on infrared reflective material and covering this with infrared transparent dye inks or pigments, or with infrared reflective dye ink or pigment printed on non-infrared reflective materials, or 2) as shown in FIG. 2a using layers of infrared reflective and infrared non-reflective (infrared transparent or infrared absorptive) materials, that make the code visible to an infrared camera with an infrared illuminator on a robot or computer vision system but invisible to the naked eye. Infrared reflective materials may include but are not limited to retroreflectors, plastics, polymers, fabrics, metals, papers, glass or ceramics. Infrared transparent material substrates may consist of but are not limited to plastics, polymers, fabrics, papers, glass or ceramics with or without infrared transparent inks or pigments. The resulting invisible infrared reflective fiducial markers can be affixed to items or built into items for identification, categorization, or instruction for interaction.

Because the reflectivity of the infrared reflector is not discernible to the human eye, these codes render as a transparent or an opaque color to the human eye. They can be printed in such a way as to blend in with complex backgrounds, even overlaid on pictures. This provides a way for robots and computer vision applications to categorize their environment without impinging on human aesthetics. The use of infrared has an added advantage of improving low light and night time readability of the fiducials.

Using infrared reflectivity for tagging also decreases the chance of misidentified objects using computer vision. Traditional computer vision relying on color and pattern in the visual spectrum can face errors in cluttered environments. These errors are reduced by using fiducial markers on infrared reflective materials, which do not occur as commonly in the natural or built environment. Under an infrared illuminator these fiducial markers become particularly visible in cluttered visual environments.

The fiducial markers in the invisible infrared reflective computer vision tag can be associated with a database of models and states that better permit robotic interaction with the world. They can instruct a robot to perform a specific action, give a robot an accurate context for state space estimation in artificial intelligence processes, they can elicit audio, visual or digital feedback from the computer vision or robotic system. It is also possible to link the individual fiducial markers with existing databases of product information by mapping tag codes to Universal Product Codes or other warehouse barcode systems.

Possible uses include but are not limited to navigation for robots in cluttered environments, navigation to charging points, identification of clothing items in fashion situations, vehicular identification, creation of digital content in augmented reality situations, creation of digital content on movie green screens, unmanned aerial vehicle navigation for recharging or delivery, tracking individual robots visually in swarms, and so forth.

As shown in FIG. 1a, a preferred embodiment for an invisible infrared reflective computer vision tag 100 includes a series of film layers, i.e., infrared reflective layer 110, a layered or printed fiducial marker 120 and an infrared transparent layer 130. For a preferred base layer 110 a retroreflective material is chosen (e.g., ASTM D4956 Type 1 or ASTM D4956 Type 3) depending on illuminator strength and preferred operating conditions (e.g., day, night or combined day and night).

A laser jet process is used on the retroreflective layer to print a fiducial marker using toner. This may be replaced by an inkjet deposition process in situations where heated drying of the retroreflector is available.

An infrared transparent layer includes a transparent film. A variety of films may be used depending on a desired rigidity of the fiducial. Infrared transparent dye pigment is applied to this layer to create either a specific pattern, matching for example a portion of a picture, or a uniform CMYK color. Application may be through inkjet, stamping or painting.

An optional shading layer may be applied either before or after the infrared transparent layer to dull the retroreflector. Specific applications will have different brightness needs and characteristics so this layer can be important for guaranteeing the fiducial marker is not washed out under the infrared illuminator. If a unidirectional camera angle is required privacy film may be utilized as the shading layer.

A sealing layer can be added to provide weatherization and UV protection.

Backing layers of adhesive or Velcro may also be added depending on the desired application.

The layering process can be done by hand or mechanically.

The resulting tags may have the fiducial identity number printed on the back before they are cut and sorted based on fiducial identity number. This is a human readable number on the back used for sorting and categorization by humans. FIG. 1b illustrates exemplary reflector-based invisible infrared reflective computer vision tags 150 being used for robotic navigation on the sides of buildings to guide unmanned aerial vehicles 160 in complex urban environments.

In other embodiments, as shown in FIG. 2a, similar tags 200 having an infrared reflective layer 210, a layered or printed fiducial marker 220 and an infrared transparent layer 230 may be produced by directly applying infrared transparent inks or pigments over fiducial markers comprised of non-infrared reflective inks or pigments directly on infrared reflective surfaces. FIG. 2b illustrates an exemplary vehicle 250 with an invisible infrared reflective computer vision tag 260 applied directly to the body of the vehicle, using layers of infrared absorptive and infrared transparent pigments. An exemplary infrared camera with infrared illuminator connected to a computer vision system 270 is also shown.

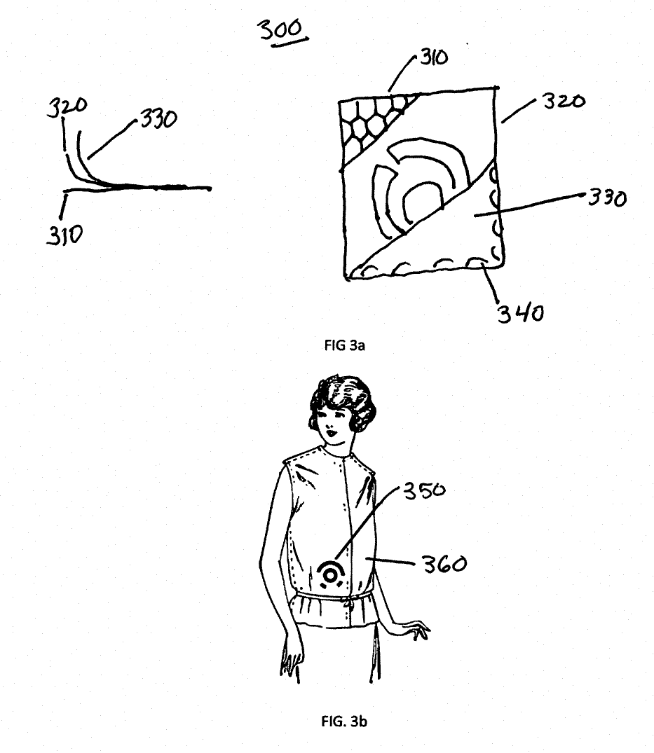

Similar tags 300 may also be produced in fabric as shown in FIG. 3a, each having an infrared reflective layer of fabric 310, a layered or printed fiducial marker 320 and an infrared transparent layer of fabric 330, stitched together 340. FIG. 3b illustrates an exemplary fabric invisible infrared reflective computer vision tag 350 as viewed under an infrared illuminator on a dress 360.

Tags may vary in size based on the requirements of the application from less than one inch square to dimensions measured in yards. The requirements of a household robot seeing an object across the room will be on the smaller side of two inches or less, but an Unmanned Aerial Vehicle flying at 10,000 feet may require large tags depending on camera optics.

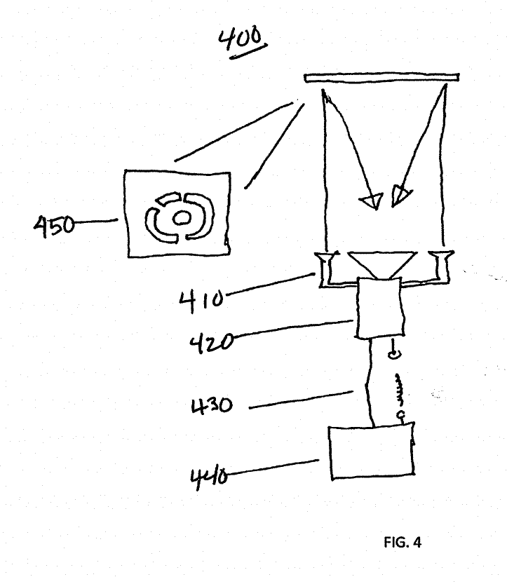

As shown in FIG. 4, components of an exemplary computer vision system 400 include an infrared illuminator 410, an infrared camera 420, and a computer 440 connected to the camera by link 430, such as Ethernet, wireless communications, USB, Thunderbolt, fiber optics, laser emitter or other communications standard. The infrared camera picks up the reflected light from the infrared illuminator and transfers the picture information to the computer. The computer then runs the software for identifying the appropriate fiducial marker, including but not limited to TopCodes, QR codes, AprilTags, or custom fiducial marker systems. The computer outputs a numeric or semantic value that can be referenced in a database for further information or returned directly to the robot or user of the computer vision system.

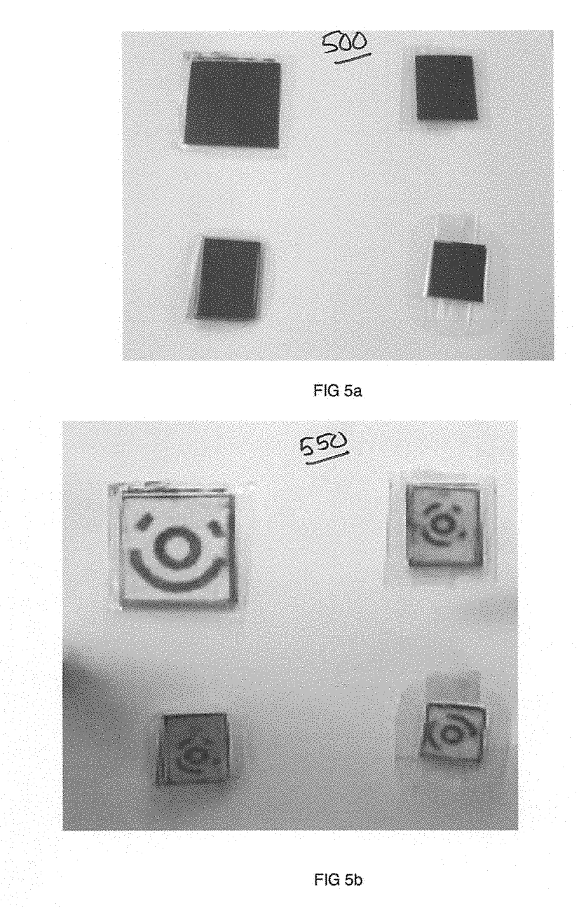

FIG. 5a illustrates an example of invisible infrared reflective computer vision tags taken by an RGB camera under typical daytime lighting conditions. These are black invisible infrared reflective computer vision tags for black surfaces and the fiducial marker on each tag renders as invisible to the human eye. Tags are placed on a white background for visibility.

FIG. 5b illustrates the same tags 550 as shown in FIG. 5a, observed through an infrared camera under an infrared illuminator. The fiducial marker represented on all four is a TopCode fiducial marker. This marker can be read by a computer vision system. Invisible infrared reflective computer vision tags will render reliably in the computer vision system at as small as 15 by 15 pixels, the same as a regular TopCode tag.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An invisible infrared reflective computer vision tag comprising:
an infrared reflective material with a printed or painted fiducial marker using an infrared opaque dye, toner, pigment or surface, covered by an infrared transparent dye toner, pigment or material.

2. The invisible infrared reflective computer vision tag of claim 1 wherein the infrared reflective material is a fabric.

3. The invisible infrared reflective computer vision tag of claim 1 wherein the infrared reflective material is a film.

4. The invisible infrared reflective computer vision tag of claim 1 wherein the infrared reflective material is a retroreflector.

5. The invisible infrared reflective computer vision tag of claim 1 wherein the infrared reflective material is a plastic.

6. The invisible infrared reflective computer vision tag of claim 1 wherein the infrared reflective material is metal.

7. The invisible infrared reflective computer vision tag of claim 1 wherein the infrared reflective material is paper.

8. The invisible infrared reflective computer vision tag of claim 1 further comprising a base material covered by layers of infrared reflective or infrared absorptive and infrared transparent pigments.

9. An invisible infrared reflective computer vision tag comprising:
an infrared opaque material with a printed or painted fiducial marker using an infrared reflective dye, toner, pigment or material, covered by an infrared transparent dye toner, pigment or surface.

10. The invisible infrared reflective computer vision tag of claim 9 wherein the infrared opaque material is selected from the group consisting of fabrics, films, plastics, glass and paper.

11. The invisible infrared reflective computer vision tag of claim 9 further comprising a base material covered by layers of infrared reflective or infrared absorptive and infrared transparent pigments.

12. An invisible infrared reflective computer vision tag comprising:
an infrared reflective layer;
a printed fiducial marker; and
an infrared transparent layer.

13. The invisible infrared reflective computer vision tag of claim 12 further comprising a sealing layer to provide weatherization and ultraviolet light protection.

14. The invisible infrared reflective computer vision tag of claim 12 further comprising one or more backing layers of adhesive.
